(19) United States
(12) Patent Application Publication
(10) Pub. No.: US 2024/0078807 A1
(43) Pub. Date: Mar. 7, 2024

(54) METHOD, APPARATUS,ELECTRONIC DEVICE AND STORAGE MEDIUM FOR VIDEO PROCESSING

(71) Applicant: Douyin Vision Co., Ltd., Beijing (CN)

(72) Inventors: Jiatong LI, Beijing (CN); Wenze FU, Beijing (CN); Gang BAI, Beijing (CN)

(21) Appl. No.: 18/459,835

(22) Filed: Sep. 1, 2023

(30) Foreign Application Priority Data
Sep. 1, 2022 (CN) 202211065122.X

(51) Int. Cl. G06V 20/40; G06T 7/73; G06V 10/74; G06V 10/774; G10L 15/02; G10L 15/06; G10L 15/08; G10L 25/57

(52) U.S. Cl. CPC G06V 20/49; G06T 7/73; G06V 10/761; G06V 10/774; G06V 20/46; G10L 15/02; G10L 15/063; G10L 15/08; G10L 25/57; G06T 2207/10016; G10L 2015/088

(57) ABSTRACT

Embodiments of the present disclosure provide method, apparatus, electronic device and storage medium for video processing. The method for video processing comprises: obtaining a plurality of video frames in a video to be processed and audio data corresponding to the video to be processed; determining a target video frame comprising a target object from the plurality of video frames through an image-text matching model; determining a target audio segment matching the target object from the audio data; determining a target video segment comprising the target video frame from the video to be processed in the case that a video corresponding to the target audio segment comprises the target video frame.

### CROSS-REFERENCE TO RELATED APPLICATION

This application claims priority to CN Application No. 202211065122.X, entitled METHOD, APPARATUS, ELECTRONIC DEVICE AND STORAGE MEDIUM FOR VIDEO PROCESSING, filed on Sep. 1, 2022, the entire contents of that application being incorporated herein by reference in its entirety.

### FIELD

Embodiments of the present disclosure generally relate to the technical field of video processing, and more specifically, to method, apparatus, electronic device and storage medium for video processing.

### BACKGROUND

The need to clip a particular item is often encountered during video processing. For example, electronic commerce live broadcast is usually presented in the form of live video to sell products, featured by a plurality of scenes, long duration, various commodities and redundant information. Creative live video clip delivery has been turned out to be an effective means of attracting people's attention, requiring video clips of specific goods.

With current video clipping technique, the video segment in which a particular item is located cannot be accurately and quickly positioned.

### SUMMARY

Embodiments of the present disclosure provide method, apparatus, electronic device and storage medium for video processing to solve the problem that the video segment in which a particular item is located cannot be accurately and quickly positioned during a video clip process.

In a first aspect, the embodiment of the present application provides a method for video processing comprising: obtaining a plurality of video frames in a video to be processed and audio data corresponding to the video to be processed; determining a target video frame comprising a target object from the plurality of video frames through an image-text matching model; determining a target audio segment matching the target object from the audio data; determining a target video segment comprising the target video frame from the video to be processed in the case that a video corresponding to the target audio segment comprises the target video frame.

In a second aspect, the embodiment of the present application provides a method for video processing comprising: an obtaining module for obtaining a plurality of video frames in a video to be processed and audio data corresponding to the video to be processed; a first determination module for determining a target video frame comprising a target object from the plurality of video frames through an image-text matching model; a second determination module for determining a target audio segment matching the target object from the audio data; a third determination module for determining a target video segment comprising the target video frame from the video to be processed in the case that a video corresponding to the target audio segment comprises the target video frame.

In a third aspect, the embodiment of the present application provides an electronic device comprising a processor, a memory and a program or instructions stored on the memory and executable on the processor, wherein the program or the instructions, when executed by the processor, implementing the steps of the method for video processing according to the first aspect.

In a fourth aspect, the embodiment of the present application provides a readable storage medium having stored thereon a program or instructions which, when executed by a processor, implementing the steps of the method for video processing according to the first aspect.

In the embodiment of the present application, a plurality of video frames in a video to be processed and audio data corresponding to the video to be processed are obtained; a target video frame comprising a target object is determined from the plurality of video frames; a target audio segment matching the target object from the audio data is determined; in the case that a video corresponding to the target audio segment comprises the target video frame, a target video segment comprising the target video frame is determined from the video to be processed. The target video segment comprising the target video frame is determined from two dimensions of the image-text matching process and the audio matching process, improving positioning accuracy of the video segment comprising the target object, solving the problem that the video segment in which a particular item is located cannot be accurately and quickly positioned during the video clip process.

### BRIEF DESCRIPTION OF THE DRAWINGS

FIG. 1 is a schematic flow diagram of a method for video processing according to embodiments of the present application;

FIG. 2 is a schematic diagram of a partitioned segment of a video to be processed according to embodiments of the present application;

FIG. 3 is a schematic flow diagram of another method for video processing according to embodiments of the present application;

FIG. 4 is a schematic diagram of determining a keyword sentence according to embodiments of the present application;

FIG. 5 is a schematic diagram of an example of determining a keyword sentence according to embodiments of the present application;

FIG. 6 is a matching schematic diagram of an image-text matching model according to embodiments of the present application;

FIG. 7 is a schematic diagram of a video processing apparatus according to embodiments of the present application;

FIG. 8 is a schematic structural diagram of an electronic device according to an embodiment of the present application.

### DETAILED DESCRIPTION OF EMBODIMENTS

The embodiments of the present invention will now be described more clearly and fully hereinafter with reference to the accompanying drawings, in which some, but not all embodiments of the invention are shown, obviously. Based on the embodiments in the present application, all the other embodiments obtained by a person of ordinary skill in the art without involving any inventive effort fall within the scope of protection of the present application.

The terms “first”, “second”, and the like in the description and in the claims, are used for distinguishing between similar items and not necessarily for describing a particular sequential or chronological order. It is to be understood that the data so used are interchangeable under appropriate circumstances such that the embodiments of the present application may be implemented in other sequences than those illustrated or otherwise described herein. The objects classified by the terms “first”, “second”, and the like usually fall into a category, without limitation to the number of objects, for example, the first object may be one or more. In addition, in the description and the claims, “and/or” means at least one of the connected objects, and the character “/” generally means that the associated object is an “or” relationship.

The method for producing props according to embodiments of the present application will now be described in detail through specific embodiments and application scenarios thereof with reference to the accompanying drawings.

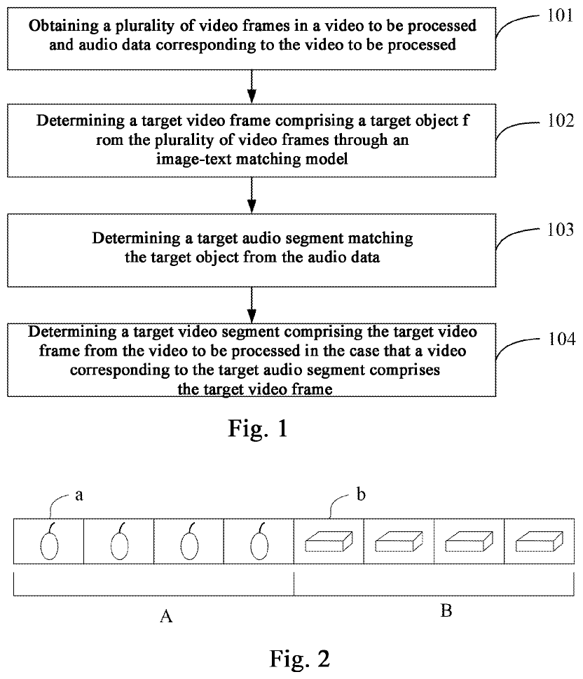

FIG. 1 illustrates a method for video processing according to an embodiment of the present application. The method may be performed by an electronic device which may comprise: a server and/or a terminal device. In other words, the method may be performed by software or hardware installed in the electronic device, the method comprising the steps of:

Step 101: obtaining a plurality of video frames in a video to be processed and audio data corresponding to the video to be processed;

Specifically, the video to be processed may be a real-time video, for example, an electronic commerce live video; it is also possible to be a record video, e. g., a movie video, etc. The type of video to be processed is not restricted.

In this step, specifically, audio-video separation may be performed on the video to be processed, and a plurality of video frames and audio data corresponding to the video to be processed may be obtained from the video to be processed.

Step 102: determining a target video frame comprising a target object from the plurality of video frames through an image-text matching model.

In particular, the target object may be any object comprised in the video to be processed. For example, in a product live video, the target object may be a commodity, which may be an apple, clothing, etc.; in the movie video, the target object may be a particular person or object or the like.

The image-text matching model may calculate the similarity between images and text to achieve the purpose of searching feature images through text. In particular, the image-text matching model may be a Contrastive Language-Image Pre-Training (CLIP) model.

In this step, an image and a keyword of the target object may be determined first, and then a target video frame comprising the target object may be determined from a plurality of video frames through the image-text matching model.

Step 103: determining a target audio segment matching the target object from the audio data.

In particular, the step may determine a target audio segment matching the target object from the audio data, enabling locating the target object from a dimension of the audio.

In one embodiment, the audio data may be converted into textual information; a text portion comprising determining a keyword of the target object from the textual information; the audio corresponding to the text portion is determined as the target audio segment.

Specifically, the present embodiment matches the keyword of the target object with the textual information converted from the audio data, determining a text portion comprising the keyword of the target object, and determining the audio corresponding to the text portion as the target audio segment. This implements the determination of the target audio segment through the match between the keyword of the target object and the audio data, the positioning of the target audio segment through the keyword of the target object, and converts the matching process of the audio and the keyword into the matching process of the text and the text, thereby improving the accuracy and ease of the audio matching.

Specifically, the text portion comprising a keyword of the target object may be a complete sentence comprising the keyword of the target object, or may be the complete sentence and a complete sentence adjacent to the complete sentence.

In addition, specifically, the keyword of the target object may be obtained by performing part-of-speech filtering on the description text of the target object; it is of course also possible to directly determine words that may describe the features of the target object as keywords.

When the keyword is obtained by performing part-of-speech filtering on the description text of the target object, multi-level description of the target object may be extracted, and the word of the multi-level description and the name of the target object may serve as the keyword. For example, as an example, assuming that the target object is a cherry, the multi-level description of the cherry may comprise fruit, imported fruit, cerasus according to the first level, the second level, and the third level, and the keyword corresponding to the cherry may comprise fruit, imported fruit, cerasus, and cherries, etc.

Step 104: in the case that a video corresponding to the target audio segment comprises the target video frame, determining a target video segment comprising the target video frame from the video to be processed.

Specifically, if the video corresponding to the target audio segment comprises the target video frame, and since the target audio segment matches the target object, and the target video frame comprises the target object, it may be demonstrated that the target video frame comprises an image of the target object, and the audio corresponding to the target video frame comprises a textual description of the target object, jointly determining the target video frame from the image dimension and the audio dimension, and thereby improving the positioning accuracy the target video frame.

In addition, if the video corresponding to the target audio segment comprises the target video frame, the target video segment comprising the target video frame may be determined from the video to be processed, and since the positioning accuracy of the target video frame is ensured, the positioning accuracy of the target video segment is ensured.

In this way, the present embodiment determines the target video frame comprising a target object from a plurality of video frames through an image-text matching model, and determines a target audio segment matching the target object from audio data. In the case that a video corresponding to the target audio segment comprises the target video frame, a target video segment comprising the target video frame is determined from the video to be processed, implementing positioning of the target video frame through the combination of the image-text matching dimension and the audio matching dimension, improving the positioning accuracy of the target video frame, thereby improving the positioning accuracy of the video segment comprising the target object and solving the problem that the video segment in which a particular item is located cannot be accurately and quickly positioned during the video clip process.

In an implementation, when a plurality of video frames in a video to be processed are obtained, the video to be processed may be partitioned according to a photographed object to obtain at least one partitioned segment, and the photographed objects corresponding to different partitioned segments are different; a preset number of video frames are extracted from at least one of the partitioned segments respectively to obtain the plurality of video frames.

The at least one partitioned segment may be a whole video segment partitioned in the video to be processed, but may also be a partial video segment.

The preset number may be set according to actual situations, for example, three.

For example, as an example, as shown in FIG. 2, as a schematic diagram of a video to be processed, assuming that a photographed object in the video to be processed comprises a cherry a and a storage box b, the video to be processed may be partitioned according to the cherry a and the storage box b to obtain a partitioned segment A corresponding to the cherry a and a partitioned segment B corresponding to the storage box b.

Specifically, the present embodiment may divide the video to be processed according to the photographed objects in the video to be processed, and different photographed objects correspond to different partitioned segments, which causes the video frames in each partitioned segment correspond to the same photographed object, i.e., the video frames comprised in one partitioned segment have a higher similarity, and the video frames comprised in different partitioned segments have a lower similarity, and therefore a pre-set number of video frames are extracted from at least one partitioned segment respectively to obtain a plurality of video frames, so that the similarity between the extracted plurality of video frames is lower. Thereby, the probability of determining a target video frame comprising an image corresponding to the target object from the plurality of video frames is guaranteed while the source data of the target video frame is guaranteed.

Furthermore, in an implementation, when a target video frame comprising an image corresponding to a target object is determined from the plurality of video frames through an image-text matching model, the following steps may be comprised:

Determining keywords of the target object; determining the target video frame according to the keyword and the plurality of video frames through an image-text matching model; wherein the image-text matching model is obtained by training sample data, the sample data comprises a sample video frame and keywords of a sample object, and the label of the sample video frame is whether the sample video frame comprises an image corresponding to the sample object.

Specifically, finding an item to be matched in a long video through an item picture may be considered as an issue of image searching with an image. If there are few sample items of the item picture, sometimes only one picture, a target detector with good performance cannot be obtained by training a depth neural network. Therefore, this embodiment may obtain a large-scale image-text matching model by training an existing object library, and obtain key words of the object so as to convert issues of image searching with an image into a text retrieval problem. The image-text matching model may accommodate hundreds of millions of data, and has strong generalization. The key words of objects and a plurality of video frames may be used as the input of the image-text matching model, thereby improving search speed and search quality of target video frames comprising target objects.

The image-text matching model is obtained by training sample data, and the sample data comprises key words of sample video frames and sample objects, which enables a target video frame to be determined based on the input key words and a plurality of video frames by the trained image-text matching model.

Of course, the video to be processed may be pre-processed first in order to improve processing efficiency and accuracy. For example, a video processing tool (such as FFMPEG) may be used to extract a series of video key frames (namely, a plurality of video frames in the present embodiment), so as to reduce the picture level required to be processed. The objects in each image are extracted based on the saliency detection method to improve the signal-to-noise ratio of each image and lay a good foundation for image-text feature matching. Based on this, a series of sequential object pictures may be obtained as a video representation.

In an implementation, determining the target video frame according to the keyword and the plurality of video frames through an image-text matching model comprises the following steps:

Performing text feature extraction on the keyword through a text encoder in the image-text matching model to obtain a text feature matrix; performing image feature extraction on the video frame through an image encoder in the image-text matching model to obtain an image feature matrix; calculating a similarity matrix between the text feature matrix and the image feature matrix; determining, according to the similarity matrix, a similarity between each of the video frames in the plurality of video frames and the target object; determining the target video frame according to the similarity.

Specifically, the image-text matching model of the present embodiment is pre-trained based on an open source universal data set, and a textual description of the target object, i.e. keywords of the target object, needs to be extracted before use. This embodiment extracts a multi-level description of a target object through an integration scheme of “multi-scale search”, and takes a first-level, a second-level and a third-level object classification of the target object and the name of the object itself as a keyword description set to perform image-text matching a plurality of times, and finally fuses matching scores to obtain a final result, improving matching robustness and accuracy.

Assuming that the image-text matching model is CLIP, the image encoder and text encoder of CLIP may be used to perform feature extraction on video frames and keywords respectively, and each feature vector extracted may be normalized in a two-norm sense, so as to facilitate subsequent similarity calculation. Assuming that the number of candidates of video frames is M, the number of keywords is N, and the dimensions of feature vectors are all K, an image feature matrix Q of M×K scale and a text feature matrix P of N×K scale are obtained respectively after this step.

First, it should be noted that the feature vector corresponding to each row of the image feature matrix Q is associated with a frame image of a specific time node. Here, a mapping relationship t=f (i) between the underline index i and the time node t of the video to be processed may be established, so that a corresponding video frame may be found from the video to be processed through the mapping relationship.

On this basis, the similarity matrix S between the image feature matrix Q and the text feature matrix P may be calculated firstly, S=Q×P\hat{ }t, wherein P\hat{ }T is a transpose of the matrix P, and the scale of the similarity matrix S is M×N, and then the similarity between each video frame in the plurality of video frames and the target object may be determined according to the similarity matrix, so that the target video frame may be determined according to the similarity. Alternatively, the reduction may be performed in a second dimension according to different fusion strategies, so as to obtain similarity vector S0 for different images, and the dimension is M×1, and each element represents the matching level of the frame image and the keyword. In this way, by combining the mapping relationship f (i) between the index and the time node, the video frame which matches the keyword of the target object most may be found, so as to implement the positioning of the target object to serve the video segment where the target object is positioned subsequently.

It should be noted that after a target video frame comprising an image corresponding to a target object is determined from a plurality of video frames, a label corresponding to a partitioned segment where the target video frame is positioned may be set. For example, continuing the above example, assuming that the target object is cherry a and the determined target video frame is a video frame in the partitioned segment A, the label of the partitioned segment A may be set as cherry, which enables label classification of the partitioned segments in the video to be processed according to the object.

In addition, in one implementation, determining a target video segment comprising the target video frame from the video to be processed comprises: obtaining a picture of the target object; determining a target video segment comprising the target video frame from the video to be processed in the case that confidence of the picture and the target video frame is greater than a preset value.

Specifically, by calculating the confidence level of the picture of the target object and the target video frame, a target video segment comprising the target video frame is determined from the video to be processed in the case that confidence of the picture and the target video frame is greater than a preset value, realizing further fine screening of the target video frame and the picture of the target object, and further improving the positioning accuracy and speed of the target video segment.

It should also be noted that if a plurality of target video frames belong to the same partitioned segment, one target video frame with the highest confidence level may be selected from the same partitioned segment, so that only one target video frame remains in each partitioned segment, facilitating positioning of the video frame where the target object is positioned.

Furthermore, in one implementation, determining a target video segment comprising the target video frame from the video to be processed comprises the following steps:

Tracking the target object in the video to be processed according to the target video frame to obtain a starting visual position and an ending visual position of the target object in the video to be processed; determining the target video segment according to the starting visual position and the ending visual position.

Specifically, the present embodiment may perform forward and backward tracking on a target object in a video to be processed according to a target video frame via a tracker, obtain the starting visual position and the ending visual position of the target object in the video to be processed, and determine the target video segment according to the starting visual position and the ending visual position so as to realize the positioning of the target video segment.

Furthermore, in one implementation, determining the target video segment according to the starting visual position and the ending visual position comprises the following steps: performing sentence breaking on the audio data, and determining a sentence breaking starting point adjacent to the starting visual position and a sentence breaking ending point adjacent to the ending visual position; determining target audio information between the sentence breaking starting point and the sentence breaking ending point; in the case that a video segment corresponding to the target audio information comprises the starting visual position and the ending visual position, determining a video segment corresponding to the target audio information as the target video segment.

In addition, since the target video segment is a visually complete segment, audio integrity is also required in order to make a creative idea, and at this moment, sentence breaking is performed on the audio data, and a sentence breaking starting point adjacent to the starting visual position and a sentence breaking ending point adjacent to the ending visual position are determined. If the video segment corresponding to the target audio information between the sentence breaking starting point and the sentence breaking ending point comprises the starting visual position and the ending visual position, the video segment corresponding to the target audio information may be determined as the target video segment, and this implements that the target video segment is not only a visually complete segment but also a complete segment on the audio, ensuring the integrity of the target video segment.

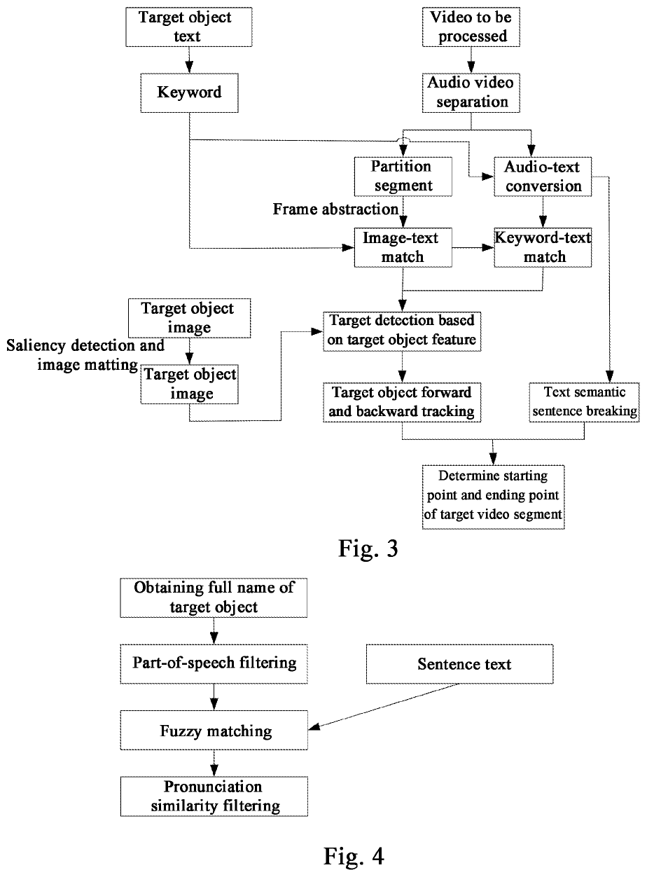

An embodiment of the present application will now be described with reference to FIG. 3, taking the electronic commerce live broadcast video and the target object as a cherry in the video as an example.

As shown in FIG. 3, the method for video processing specifically comprises the following steps:

Firstly, performing audio and video separation on a video to be processed to obtain audio data corresponding to the video to be processed; with regard to the video after audio and video separation, the video to be processed is partitioned according to the photographed object to obtainedifferent partitioned segments corresponding to different photographed objects. Of course, the video to be processed may be mirrored here to obtainedifferent partitioned segments corresponding to different scenes.

Then, a preset number of video frames may be extracted from the at least one partitioned segment respectively to obtain a plurality of video frames. For example, 3 video frames are extracted from each partitioned segment, resulting in a plurality of video frames.

The keyword of the target object may then be determined and in particular may be extracted from the textual description of the target object. For example, the keywords of the target object cherry at this time may comprise fruit, imported fruit, cerasus, and cherries, etc.; the determined keyword and the obtained a plurality of video frames are input into an image-text matching model, and the target video frame comprising an image corresponding to a cherry is determined through the image-text matching model.

Specifically, when extracting a keyword of a target object, a keyword statement may be extracted from a video to be processed first, and the keyword may be extracted from the keyword statement. As shown in FIG. 4, when a keyword statement is extracted, a full name of a target object may be obtained first, and part-of-speech filtering may be performed; then the sentence text corresponding to the audio data of the video to be processed is obtained through an automatic speech recognition technology; fuzzy matching is performed on words and sentence text after part of speech filtering and pronunciation similarity filtering is performed to obtain keyword sentences.

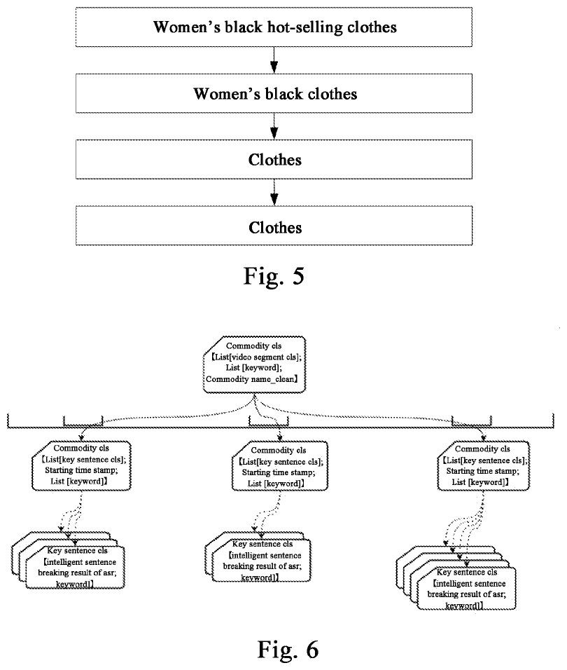

As an example, as shown in FIG. 5, assuming that the full name of the commodity is “women's black hot-selling clothes”, and “women's black clothes” is obtained after parts of speech and modifiers filtering etc.; then fuzzy matching and pronunciation matching are performed to obtain “clothes”. Finally, non-Maximum Suppression (NMS) is performed on the whole video to obtain “clothes”.

Further, in particular, a specific process of determining a target video frame through the teletext matching model may be as shown in FIG. 6. Assuming that the image-text matching model is CLIP, the image encoder and text encoder of CLIP may be used to perform feature extraction on video frames and keywords respectively, and each feature vector extracted may be normalized in a two-norm sense, so as to facilitate subsequent similarity calculation. Assuming that the number of candidates of video frames is M, the number of keywords is N, and the dimensions of feature vectors are all K, an image feature matrix Q of M×K scale and a text feature matrix P of N×K scale are obtained respectively after this step.

First, it should be noted that the feature vector corresponding to each row of the image feature matrix Q is associated with a frame image of a specific time node. Here, a mapping relationship t=f (i) between the underline index i and the time node t of the video to be processed may be established, so that a corresponding video frame may be found from the video to be processed through the mapping relationship.

On this basis, the similarity matrix S between the image feature matrix Q and the text feature matrix P may be calculated firstly, S=Q×P\hat{ }t, wherein P\hat{ }T is a transpose of the matrix P, and the scale of the similarity matrix S is M×N, and then the similarity between each video frame in the plurality of video frames and the target object may be determined according to the similarity matrix, so that the target video frame may be determined according to the similarity. Alternatively, the reduction may be performed in a second dimension according to different fusion strategies, so as to obtain similarity vector S0 for different images, and the dimension is M×1, and each element represents the matching level of the frame image and the keyword. In this way, by combining the mapping relationship f (i) between the index and the time node, the video frame which matches the keyword of the target object most may be found, so as to implement the positioning of the target object to serve the video segment where the target object is positioned subsequently.

It should be noted that after a target video frame comprising an image corresponding to a target object is determined from a plurality of video frames, a label corresponding to a partitioned segment where the target video frame is positioned may be set. For example, continuing the above example, assuming that the target object is cherry a and the determined target video frame is a video frame in the partitioned segment A, the label of the partitioned segment A may be set as cherry, which enables label classification of the partitioned segments in the video to be processed according to the object.

Then, the audio data of the video to be processed is converted into textual information, a text portion comprising the keyword of the target object “cherry” is determined from the textual information, and the audio corresponding to the text portion is determined as a target audio segment. At this time, if the video frame corresponding to the target audio segment comprises the target video frame, proceeding to the next step so as to implement further accurate positioning on the target video frame.

Then, a picture of the target cherry is taken. Specifically, as the cherry picture contains other background information such as cherry logo, it will cause misjudgment. Therefore, it is necessary to detect the saliency of common objects and perform image matting and get a clean cherry target map. In addition, it is also necessary to calculate the confidence level of the picture and the target video frame, and a target video segment comprising the target video frame from the video to be processed is determined in the case that a confidence level of the picture and the target video frame is greater than a preset value. Of course, if there a plurality of target video frames belonging to the same partitioned segment, the target video frame with the highest confidence may be selected from the partitioned segment.

Specifically, when calculating the confidence level of a picture and a target video frame, all the known object graphs in the video to be processed may be used to extract edge statistical features (such as HOG) and color features (such as color name), and the feature graph is cascaded as a plurality of object feature templates, and corresponding object target detection is performed on the target video frame to obtain a frame with the highest confidence level of a partitioned segment.

The target object may then be tracked forward and backward using the tracker to obtain the starting and ending visual positions of the target object cherry in the video.

Then, since the target video segment is a visually complete segment, audio integrity is also required in order to make a creative idea, and at this moment, sentence breaking is performed on the audio data, and a sentence breaking starting point adjacent to the starting visual position and a sentence breaking ending point adjacent to the ending visual position are determined. If the video segment corresponding to the target audio information between the sentence breaking starting point and the sentence breaking ending point comprises the starting visual position and the ending visual position, the video segment corresponding to the target audio information may be determined as the target video segment, and this implements that the target video segment is not only a visually complete segment but also a complete segment on the audio, ensuring the integrity of the target video segment.

Specifically, after the target video segment is determined, the target video segment may be clipped from the video to be processed, or visual processing may be performed, etc.

Thus, through the above-mentioned process, the target video frame and the target video segment are determined through the two dimensions of the image-text matching process and the audio matching process, improving positioning accuracy of the video segment comprising the target object, solving the problem that the video segment in which a particular item is located cannot be accurately and quickly positioned.

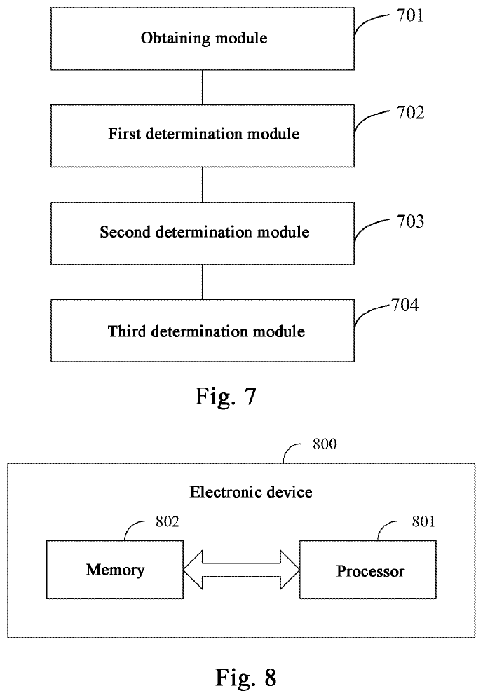

FIG. 7 is a schematic diagram of a video processing apparatus according to an embodiment of the present application. As shown in FIG. 7, the video processing apparatus comprises:

An obtaining module 701 for obtaining a plurality of video frames in a video to be processed and audio data corresponding to the video to be processed.

A first determination module 702 for determining a target video frame comprising a target object from the plurality of video frames through an image-text matching model.

A second determination module 703 for determining a target audio segment matching the target object from the audio data.

A third determination module 704, in the case that a video corresponding to the target audio segment comprises the target video frame, determining a target video segment comprising the target video frame from the video to be processed.

In one implementation, the first determination module 702 is specifically used to determine a keyword of the target object; determine the target video frame according to the keyword and the plurality of video frames through an image-text matching model; wherein the image-text matching model is obtained by training sample data, and the sample data comprises a sample video frame and a keyword of a sample object, and a label of the sample video frame is whether the sample video frame comprises an image corresponding to the sample object.

In one implementation, the first determination module 702 is specifically used to perform text feature extraction on the keyword via a text encoder in the image-text matching model to obtain a text feature matrix; perform image feature extraction on the video frame via an image encoder in the image-text matching model to obtain an image feature matrix; calculate a similarity matrix between the text feature matrix and the image feature matrix; determine, according to the similarity matrix, a similarity between each of the video frames in the plurality of video frames and the target object; determine the target video frame according to the similarity.

In one implementation, the second determination module 703 is used to convert the audio data into textual information; determine a text portion comprising a keyword of the target object from the textual information; determine the audio corresponding to the text portion as the target audio segment.

In one implementation, an obtaining module 701 is used to partition the video to be processed according to a photographed object to obtain at least one partitioned segment, wherein the photographed objects corresponding to different partitioned segments are different; extract a preset number of video frames from the at least one partitioned segment respectively to obtain the plurality of video frames.

In one implementation, the third determination module 704 is used to obtain a picture of the target object; determine a target video segment comprising the target video frame from the video to be processed in the case that confidence of the picture and the target video frame is greater than a preset value.

In one implementation, the third determination module 704 is used to track the target object in the video to be processed according to the target video frame to obtain a starting visual position and an ending visual position of the target object in the video to be processed; determine the target video segment according to the starting visual position and the ending visual position.

In one implementation, the third determination module 704 is used to perform sentence breaking on the audio data, and determine a sentence breaking starting point adjacent to the starting visual position and a sentence breaking ending point adjacent to the ending visual position; determine target audio information between the sentence breaking starting point and the sentence breaking ending point; in the case that a video segment corresponding to the target audio information comprises the starting visual position and the ending visual position, determine a video segment corresponding to the target audio information as the target video segment.

The video processing apparatus provided by the embodiments of the present application may implement the various processes implemented by the method embodiments of FIGS. 1 to 6, and in order to avoid repetition, the description thereof will not be repeated here.

It should be noted that the embodiment of the video processing apparatus in the present description is based on the same inventive concept as the embodiment of the method for video processing in the present description. Therefore, with regard to the specific implementation of the embodiment of the video processing apparatus, reference may be made to the corresponding implementation of the embodiment of the method for video processing in the foregoing description, and the description thereof will not be repeated.

The video processing device in the embodiments of the present application may be a device or may be a component, an integrated circuit, or a chip in a terminal. The apparatus may be a mobile electronic device or a non-mobile electronic device. By way of example, the mobile electronic device may be a mobile phone, a tablet computer, a notebook computer, a palmtop computer, a vehicle-mounted electronic device, a wearable device, an ultra-mobile personal computer (UMPC), a webbook or a personal digital assistant (PDA), etc. and the non-mobile electronic device may be a server, a Network Attached Storage (NAS), a personal computer (PC), a television (TV), a teller machine or a self-help machine, etc. and the embodiments of the present application are not particularly limited.

The video processing apparatus in the embodiment of the present application may be an apparatus having an operating system. The operating system may be an Android operating system, may be an iOS operating system, and may also be other possible operating systems, and the embodiments of the present application are not particularly limited.

Based on the same technical concept, as shown in FIG. 8, the embodiment of the present application also provides an electronic device 800, comprising a processor 801 and a memory 802, wherein the memory 802 stores a program or instruction which can run on said processor 801, and when executed by the processor 801, the program or instruction realizes: obtaining a plurality of video frames in a video to be processed and audio data corresponding to said video to be processed; from said plurality of video frames, determining a target video frame comprising a target object through an image-text matching model; determining a target audio piece from the audio data matching the target object; and in the case that the video corresponding to the target audio segment comprises the target video frame, determining a target video segment comprising the target video frame from the video to be processed.

The specific execution steps may be seen from various steps of the above-mentioned method for video processing embodiments, and can achieve the same technical effect, and in order to avoid repetition, the description thereof will not be repeated here.

It should be noted that the electronic device in the embodiment of the present application comprises: A server, a terminal or a device other than a terminal.

The above electronic device structure does not constitute a limitation on the electronic device, and the electronic device may comprise more or less components than those illustrated, or some components may be combined, or different component arrangements may be provided, for example, the input unit may comprise a Graphics Processing Unit (GPU) and a microphone, and the display unit may configure a display panel in the form of a liquid crystal display, an organic light emitting diode, etc. The user input unit comprises at least one of a touch panel and other input devices. Touch panels are also referred to as touch screens. Other input devices may comprise, but are not limited to, a physical keyboard, function keys (e. g., volume control keys, switch keys, etc.), a trackball, a mouse, a joystick, etc. which will not be described in detail herein.

The memory may be used to store software programs as well as various data. The memory may mainly comprise a first memory area storing programs or instructions and a second memory area storing data, wherein the first memory area may store an operating system, applications or instructions required for at least one function (such as a sound play function, an image play function, etc.), etc. Additionally, the memory can comprise volatile memory or nonvolatile memory, or the memory can comprise both volatile and nonvolatile memory. Among other things, the non-volatile Memory may be read-only memory (ROM), programmable read-only memory (Programmable ROM, PROM), erasable programmable read-only memory (Erasable PROM, EPROM), electrically erasable programmable read-only memory (Electrically EPROM, EEPROM), or flash memory. Volatile memories may be Random Access Memory (RAM), static RAM (SRAM), dynamic RAM (DRAM), synchronous DRAM (SDRAM), double Data Rate SDRAM (DDRSDRAM), enhanced SDRAM (ESDRAM), synchlink DRAM (SLDRAM), and Direct Rambus RAM (DRRAM).

The processor may comprise one or more processing units. Optionally, the processor integrates an application processor that primarily handles operations involving the operating system, user interface, application programs, etc. and a modem processor that primarily handles wireless communication signals, such as baseband processors. It will be appreciated that the modem processor described above may not be integrated into the processor.

The embodiments of the present application also provide a readable storage medium having stored thereon a program or instructions which, when executed by a processor, implement the various processes of the above-mentioned embodiments of the method for video processing and can achieve the same technical effects, and in order to avoid repetition, the description thereof will not be repeated here.

The processor is a processor in the electronic device described in the above embodiment. The readable storage medium comprises a computer readable storage medium such as a computer read-only Memory (ROM), a Random Access Memory (RAM), a magnetic or optical disk, etc.

The embodiments of the present application further provide a chip, wherein said chip comprises a processor and a communication interface, and said communication interface is coupled to said processor, and said processor is used for running a program or instructions to implement various processes of the above-mentioned method embodiments and can achieve the same technical effect, and in order to avoid repetition, the description thereof will not be repeated.

It should be understood that a chip referred to in embodiments of the present application may also be referred to as a system-on-a-chip, a system-on-a-chip, a system-on-a-chip, or the like.

It should be noted that, as used herein, the terms “comprises”, “comprising”, or any other variation thereof, are intended to cover a non-exclusive inclusion, such that a process, method, article, or apparatus that comprises a list of elements does not comprise only those elements but may comprise other elements not expressly listed or inherent to such process, method, article, or apparatus. An element proceeded by “comprises a” does not, without more constraints, preclude the existence of additional identical elements in the process, method, article, or apparatus that comprises the element. Furthermore, it should be noted that the scope of the methods and apparatus in the embodiments of the present application is not limited to the order of performing the functions shown or discussed, and may comprise performing the functions in a substantially simultaneous manner or in a reverse order depending on the functionality involved, e. g., the methods described may be performed in a different order than described and various steps may be added, omitted, or combined. In addition, features described with reference to certain examples may be combined in other examples.

From the description of the embodiments given above, it will be clear to a person skilled in the art that the method of the embodiments described above may be implemented by means of software plus a necessary general purpose hardware platform, but of course also by means of hardware, the former being in many cases a better embodiment. Based on this understanding, the technical solution of the present application, in essence or in part contributing to the prior art, may be embodied in the form of a software product, wherein the computer software product is stored in a storage medium (such as a ROM/RAM, a magnetic disk, an optical disk), and comprises instructions for causing a terminal (which may be a mobile phone, a computer, a server, an air conditioner, or a network device, etc.) to execute the method described in the various embodiments of the present application.

Although the embodiments of the present application have been described above with reference to the accompanying drawings, the present application is not limited to the above-mentioned specific embodiments, which are merely illustrative and not restrictive, and those skilled in the art, with the inspiration from the present application, can make many changes without departing from the spirit and scope of the present application and the appended claims.

I/We claim:

1. A method for video processing comprising:
obtaining a plurality of video frames in a video to be processed and audio data corresponding to the video to be processed;
determining a target video frame comprising a target object from the plurality of video frames through an image-text matching model;
determining a target audio segment matching the target object from the audio data;
determining a target video segment comprising the target video frame from the video to be processed in the case that a video corresponding to the target audio segment comprises the target video frame.

2. The method for video processing of claim 1, wherein determining the target video frame comprising the target object from the plurality of video frames through the image-text matching model comprises:
determining a keyword of the target object;
determining the target video frame through the image-text matching model according to the keyword and the plurality of video frames;
wherein the image-text matching model is obtained by training sample data, and the sample data comprises a sample video frame and a keyword of a sample object, and a label of the sample video frame is whether the sample video frame comprises an image corresponding to the sample object.

3. The method for video processing of claim 2, wherein determining the target video frame through the image-text matching model according to the keyword and the plurality of video frames comprises:
performing text feature extraction on the keyword through a text encoder in the image-text matching model to obtain a text feature matrix;
performing image feature extraction on the video frame through an image encoder in the image-text matching model to obtain an image feature matrix;
calculating a similarity matrix between the text feature matrix and the image feature matrix;
determining, according to the similarity matrix, a similarity between each of the video frames in the plurality of video frames and the target object;
determining the target video frame according to the similarity.

4. The method for video processing of claim 1, wherein determining the target audio segment matching the target object from the audio data comprises:
converting the audio data into textual information;
determining a text portion comprising a keyword of the target object from the textual information;
determining the audio corresponding to the text portion as the target audio segment.

5. The method for video processing of claim 1, wherein obtaining the plurality of video frames in the video to be processed comprises:
partitioning the video to be processed according to photographed objects to obtain at least one partitioned segment, wherein the photographed objects corresponding to different partitioned segments are different;
extracting a preset number of video frames from the at least one partitioned segment respectively to obtain the plurality of video frames.

6. The method for video processing of claim 1, wherein determining the target video segment comprising the target video frame from the video to be processed comprises:
obtaining a picture of the target object;
determining a target video segment comprising the target video frame from the video to be processed in the case that a confidence level of the picture and the target video frame is greater than a preset value.

7. The method for video processing of claim 1, wherein determining the target video segment comprising the target video frame from the video to be processed comprises:
tracking the target object in the video to be processed according to the target video frame to obtain a starting visual position and an ending visual position of the target object in the video to be processed;
determining the target video segment according to the starting visual position and the ending visual position.

8. The method for video processing of claim 7, wherein determining the target video segment according to the starting visual position and the ending visual position comprises:
performing sentence breaking on the audio data, and determining a sentence breaking starting point adjacent to the starting visual position and a sentence breaking ending point adjacent to the ending visual position;
determining target audio information between the sentence breaking starting point and the sentence breaking ending point;
determining a video segment corresponding to the target audio information as the target video segment in the case that a video segment corresponding to the target audio information comprises the starting visual position and the ending visual position.

9. A video processing apparatus comprising:
an obtaining module for obtaining a plurality of video frames in a video to be processed and audio data corresponding to the video to be processed;
a first determination module for determining a target video frame comprising a target object from the plurality of video frames through an image-text matching model;
a second determination module for determining a target audio segment matching the target object from the audio data;
a third determination module for determining a target video segment comprising the target video frame from the video to be processed in the case that a video corresponding to the target audio segment comprises the target video frame.

10. An electronic device comprising a processor, a memory and a program or instructions stored on the memory and executable on the processor, wherein the program or the instructions, when executed by the processor, implementing the steps of the method for video processing according to claim 1.

11. A readable storage medium having stored thereon a program or instructions which, when executed by a processor, implementing the steps of the method for video processing according to claim 1.
